(19) United States
(12) Patent Application Publication
(10) Pub. No.: US 2025/0326334 A2
(43) Pub. Date: Oct. 23, 2025

(54) BASE ASSEMBLY AND CHILD SAFETY SEAT

(71) Applicant: Wonderland Switzerland AG, Steinhausen (CH)

(72) Inventor: Xiaolong MO, Guangdong (CN)

(21) Appl. No.: 18/726,580

(22) PCT Filed: Jan. 9, 2023
(86) PCT No.: PCT/EP2023/050293

§ 371 Date: Jul. 3, 2024

(30) Foreign Application Priority Data
Jan. 7, 2022 (CN) 202210015401.9
Jun. 20, 2022 (CN) 202210699166.1

(51) Int. Cl. B60N 2/26; B60N 2/90

(52) U.S. Cl. CPC B60N 2/274; B60N 2/933

(57) ABSTRACT

The application discloses a base assembly and a child safety seat. The base assembly includes: a base including a base bracket; a support leg; a slider including a slider bracket, the slider bracket being disposed slidably on the base bracket, and the support leg being pivotably connected to the slider and telescoped with the slider; and a locking member for locking the slider bracket to the base bracket. The base assembly and the child safety seat provided by the application simplify the operation of the user, so that the operation is simple and convenient, and the user experience is improved

This application is a National Stage application of PCT/EP2023/050293, filed on Jan. 9, 2023, which claims the benefit of Chinese Application No. 202210015401.9, filed on Jan. 7, 2022 and Chinese Application No. 202210699166.1, filed on Jun. 20, 2022, all of which are incorporated herein by reference in their entirety.

### TECHNICAL FIELD

The application relates to the technical field of a child safety seat, in particular to a base assembly and a child safety seat.

### BACKGROUND

A child safety seat has become an essential carrier for children to travel. In order to improve its stability and use safety, a support leg is arranged on a base. When in use, the support leg is unfolded and touches the ground, so that the child safety seat can be well supported to prevent the child safety seat from overturning. When not in use, the support leg can be folded at the bottom of the base to reduce a packaging volume.

In order to reduce the packaging volume, the support leg can be arranged to pivotable and slidable relative to the base. For more convenient operation, it is necessary to release sliding of the support leg while the support leg is pivoted. However, the current pivoting and sliding structures of the support leg are complex, and the user experience is not good.

### SUMMARY

The application provides a base assembly, including: a base; a support leg; a slider disposed slidably on the base, the support leg being pivotably connected to the slider and telescoped with the slider; and a locking member for locking the slider to the base.

The application also provides a base assembly, including: a base; a support leg; a slider disposed slidably on the base, the support leg being pivotably connected to the slider and moves telescopically with the slider relative to the base; a driving member; and a locking structure, in responsive to pivot of the support leg, the driving member being connected with the support leg, and the slider being locked or unlocked with the base.

In another aspect, the present application provides a child safety seat, which includes the base assembly and a seat arranged on the base assembly.

### BRIEF DESCRIPTION OF THE DRAWINGS

The various objects, features and advantages of the invention will become more apparent by considering the following detailed description of preferred embodiments of the invention in conjunction with the accompanying drawings. The drawings are only exemplary illustrations of the present invention and are not necessarily drawn to scale. Throughout the drawings like reference numerals denote identical or similar parts throughout, in which:

FIG. 1 is a perspective view of a base assembly according to the present application;

FIG. 2 is a perspective view of a base assembly according to the present application with a part of components not depicted so as to show an internal structure;

FIG. 3 is an enlarged partial view of part A of FIG. 2;

FIG. 4 is a partial top view of a base assembly according to the present application with a part of components not depicted so as to show an internal structure;

FIG. 5 is a sectional view taken along line C-C of FIG. 4 with a slider in a locked state;

FIG. 6 is a sectional view taken along line C-C of FIG. 4 with a slider in an unlocked state;

FIG. 7 is a sectional view taken along line B-B of FIG. 4 with a slider in a locked state;

FIG. 8 is a sectional view taken along line B-B of FIG. 4 with a slider in an unlocked state;

FIG. 9 is a partial cross-sectional view of a base assembly according to the present application with a unlocking member not depicted;

FIG. 10 is a perspective view of two locking members of a base assembly according to the present application;

FIG. 11 is a bottom perspective view of a base assembly according to the present application;

FIG. 12 is a partial perspective view of a base assembly according to another embodiment of the present application with a part of components not depicted to show an internal structure;

FIG. 13 is a partial cross-sectional view of a base assembly according to another embodiment of the present application;

FIG. 14 is a partial cross-sectional view of a base assembly according to another embodiment of the present application;

FIG. 15 is a partial cross-sectional view of a base assembly according to another embodiment of the present application;

FIG. 16 is a partial perspective view of a base assembly according to another embodiment of the present application;

FIG. 17 is a partial cross-sectional view of a base assembly according to another embodiment of the present application with a slider in a locked state;

FIG. 18 is a partial cross-sectional view of a base assembly according to another embodiment of the present application with a slider in an unlocked state;

FIG. 19 is a perspective view of a base assembly according to the present application with a support leg in an unfolded position;

FIG. 20 is a perspective view of a base assembly according to the present application with a support leg in a folded position;

FIG. 21 is a perspective view of a base assembly according to the present application with a part of components removed to show an internal structure of the base assembly;

FIG. 22 is a partial perspective view of an internal structure of a base assembly according to the present application, wherein a locking member covers a locking hole;

FIG. 23 is a partial perspective view of an internal structure of a base assembly according to the present application from another perspective, wherein a locking member is deviated from a locking hole;

FIG. 24 is a partial perspective view of an internal structure of a base assembly according to the present application from another perspective, wherein a locking member covers a locking hole;

FIG. 25 is a partial cross-sectional view of a base assembly according to the present application with a support leg proximate an unfolded position;

FIG. 26 is a partial cross-sectional view of a base assembly according to the present application with a support leg proximate a folded position;

FIG. 27 is a partial cross-sectional view of a base assembly according to the present application with a locking member not inserted into a locking hole;

FIG. 28 is a partial cross-sectional view of a base assembly according to the present application with a locking member inserted into a locking hole;

FIG. 29 is a partial perspective view of an internal structure of a base assembly according to the present application;

FIG. 30 is a partial perspective view of an internal structure of a base assembly according to the present application;

FIG. 31 is a partial perspective view of an internal structure of a base assembly according to the present application;

FIG. 32 is a perspective view of a bushing of a base assembly according to the present application; and

FIG. 33 is a perspective view of a portion of a bushing of a base assembly according to the present application.

### LIST OF REFERENCE NUMBERS

base assembly 1
   base 10
      base upper cover 11
      base lower cover 12
         buffer 121
         fixed shaft 122
      decorative cover 13
      base bracket 160
         locking hole 161
         recess 162
      receiving groove 170
      locking member 180
   support leg 20
      first section 210
      rotation support 210a
      second section 220
      pivot 230
   slider 30
      slider bracket 340
         slider groove 341
         slider rod 342a
         locking hole 342
         fixing portion 343
         arc-shaped groove 344
      restoring member 350
      elastic member 350a
      driving member 360
         first end 361
         second end 362
   conversion structure 60
      end 610
      pivot portion 620
      linkage member 630
   unlocking member 80
      cam 810
         push protrusion 811
   locking member 90
      bushing 910
         bushing half body 910′
         positioning arm 911
         annular rib 911a
         hook 912
      elastic member 920
      reset member 920a
      locking pin 930
      locking member 930a
         through hole 931
      arm portion 940
         convex portion 941
         locking portion 942
         limiting portion 943
      fixing cover 950
      mounting seat 950a
         chamber 951
      fixing seat 960

### DETAILED DESCRIPTION

For a clearer explanation of the overall concept of the present application, a detailed description is given by way of example in conjunction with the accompanying drawings of the specification.

It should be noted that many specific details are set forth in the following description to facilitate a full understanding of the present application, but the present application may also be practiced in other ways other than those described herein, and therefore the scope of protection of the present application is not limited by the specific embodiments disclosed below

In addition, in the description of this application, it should be understood that the terms such as “center”, “upper”, “lower”, “front”, “back”, “left”, “right”, “vertical”, “horizontal”, “top”, “bottom”, “inner”, “outer”, “axial”, “radial”, “circumferential” and the like indicate an orientation or positional relationship based on the drawings, which is intended for ease of description and simplification of the description only, and is not intended to indicate or imply that the recited device or assembly must have a particular orientation, be constructed and operate in a particular orientation, and thus cannot be construed as limiting of the application.

In this application, the terms such as “mounted”, “coupled”, “connected”, “fixed”, and the like should be understood in a broad sense and may be, for example, a fixed connection, a detachable connection, or integral, unless otherwise expressly specified and limited. It can be a directly connection, an indirectly connection through intermediate media, an internal connection of two components, or an interaction relationship between two components. However, indicating the direct connection means that that the connection between the two subjects does not build a connection relationship through a transition structure, but only forms a whole through the connection structure. The specific meanings of the above terms in the present application may be understood according to the specific situation to those of ordinary skill in the art.

In this application, the first feature being “above” or “below” the second feature may be a direct contact between the first and second features, or an indirect contact between the first and second features via intermediate media, unless otherwise expressly specified and defined. In the description of this specification, descriptions of the reference terms such as “one embodiment”, “some embodiments”, “example”, “specific example”, “some examples”, and the like mean that specific features, structures, materials, or characteristics described in connection with the embodiment or example are included in at least one embodiment or example of the application. In the present specification, the schematic expression of the above terms need not be directed to the same embodiments or examples. Further, the specific features, structures, materials or characteristics described may be combined in a suitable manner in any one or more embodiments or examples.

The present application provides a base assembly 1 and a child safety seat including the base assembly 1. The child safety seat may be installed on a seat of a car for infants or children to seat and ensure the safety of the passenger.

A first embodiment of the present application will be described below.

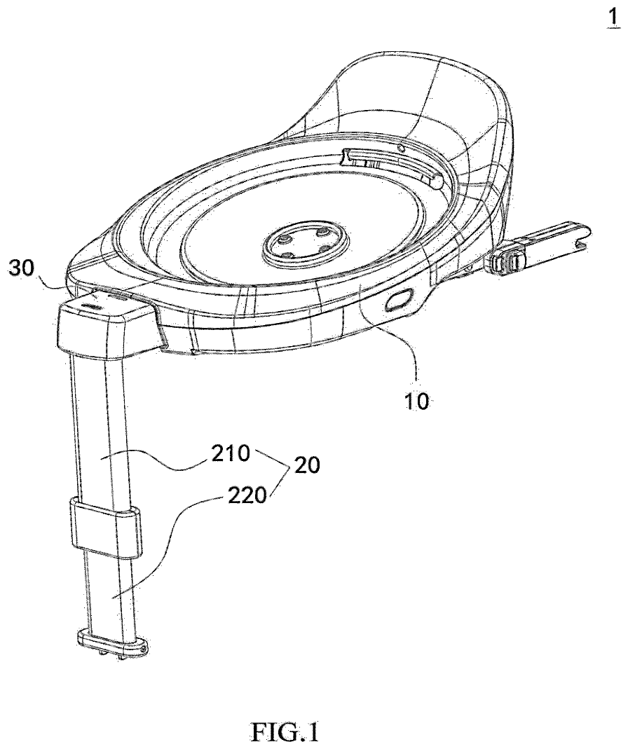

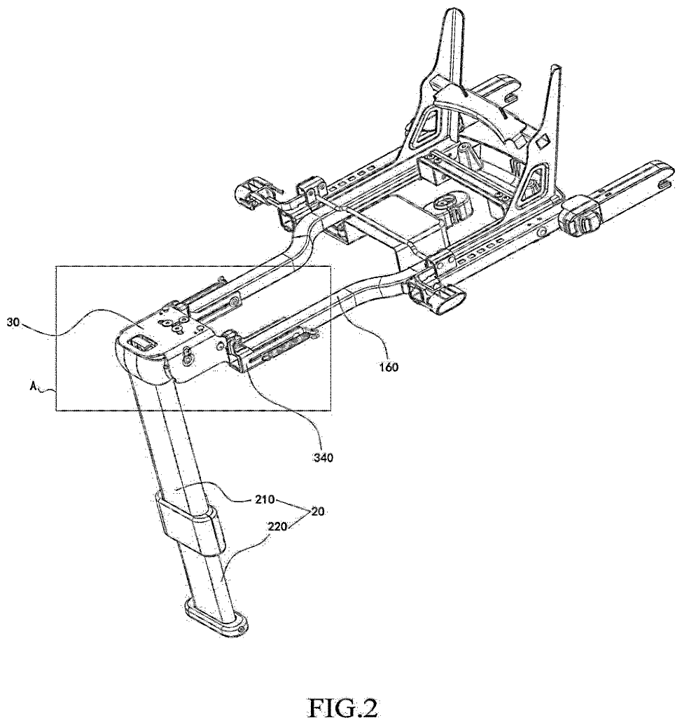

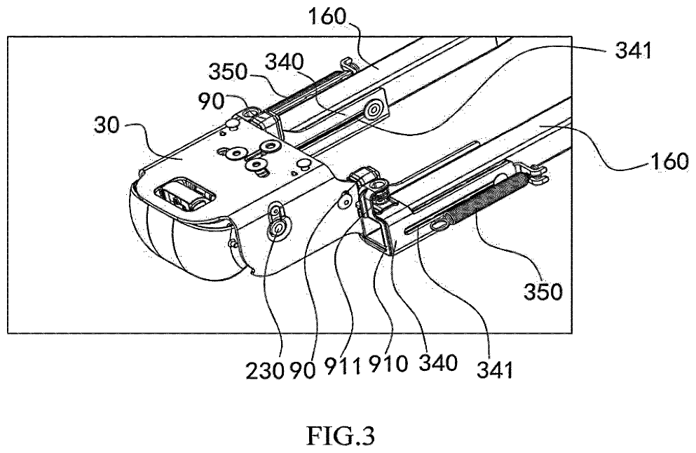

FIG. 1 is a perspective view of a base assembly according to the present application. FIG. 2 is a perspective view of a base assembly according to the present application with a part of components removed to show an internal structure. FIG. 3 is an enlarged partial view of part A of FIG. 2.

Referring to FIGS. 1-3, a child safety seat may have a base assembly 1 and a seat (not shown). The base assembly 1 may have a base 10, a support leg 20, a slider 30, and a locking member 90. The seat may be disposed rotatably on the base 10 and may have at least one forward position and one backward position. The forward position may be a position in which the seat faces the front of a vehicle, and the backward position may be a position in which the seat faces the rear of the vehicle. The forward position may for example be applicable to older children and the backward position may for example be applicable to younger infants, but the present application is not limited thereto.

The support leg 20 is rotatably and telescopically connected to the base 10. For example, the support leg 20 may be pivotably connected to the slider 30 by means of a pivot 230. When the support leg 20 is used, the support leg 20 can extend out of the base 10 and turn out to touch the ground, thus preventing the child safety seat from overturning during impact. When the support leg 20 is not used, the support leg 20 can be synchronously rotated and contracted to the bottom of the base 10. In this way, the overall size of the child safety seat may be reduced, so that it is convenient to store and use.

The base 10 may include a base bracket 160. The slider 30 may include a slider bracket 340. The slider bracket 340 is disposed slidably on the base bracket 160, and the support leg 20 is pivotably connected to the slider 30 and telescoped with the slider 30. The locking member 90 may lock the slider bracket 340 to the base bracket 160.

The support leg 20 may include a first section 210 and a second section 220. The first section 210 and the second section 220 may form a sleeve-like structure, and the second section 220 may be disposed inside the first section 210 and movable relative to the first section 210 to elongate or shorten the support leg 20.

The base bracket 160 may be used as a carrier to bear the main weight of the base assembly 1. The slider bracket 340 may be sleeved on the base bracket 160. Each of the base bracket 160 and the slider bracket 340 may be symmetrically formed on both sides of the base assembly 1, but the present application is not limited thereto. A slider groove 341 may be provided on the slider bracket 340 to limit a distance of movement of the slider bracket 340 relative to the base bracket 160 by, for example, a pin. Alternatively, the slider groove 341 may also be formed on the base bracket 160. A restoring member 350 may be formed between the base bracket 160 and the slider bracket 340. The restoring member 350 may apply a force to the slider bracket 340 to move the slider bracket 340 in a direction extending out of the base assembly 1.

A bushing 910 may be provided between the base bracket 160 and the slider bracket 340. The bushing 910 may cause a smooth slide between the base bracket 160 and the slider bracket 340. The bushing 910 may be attached to the slider bracket 340 for movement with the slider bracket 340.

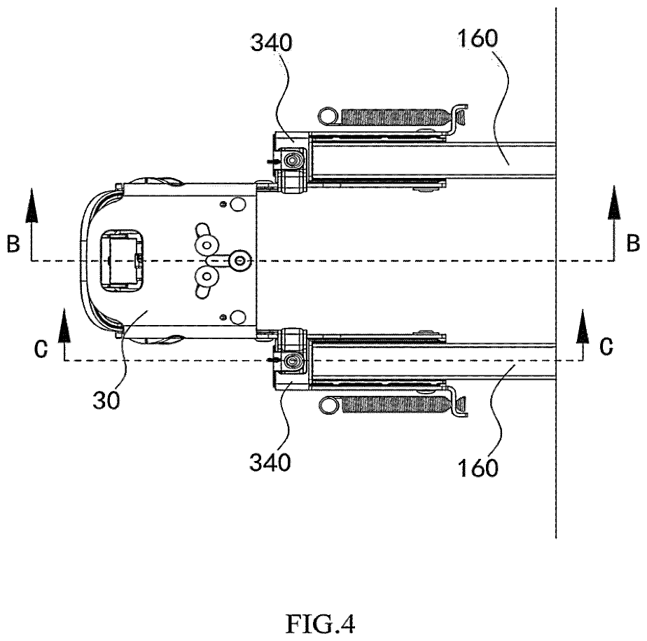

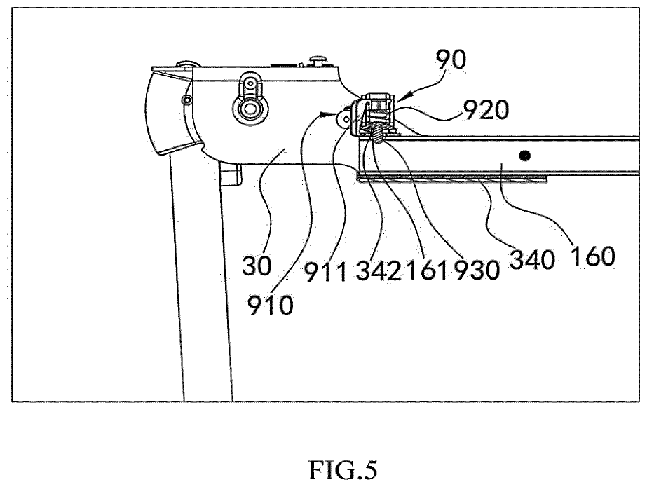

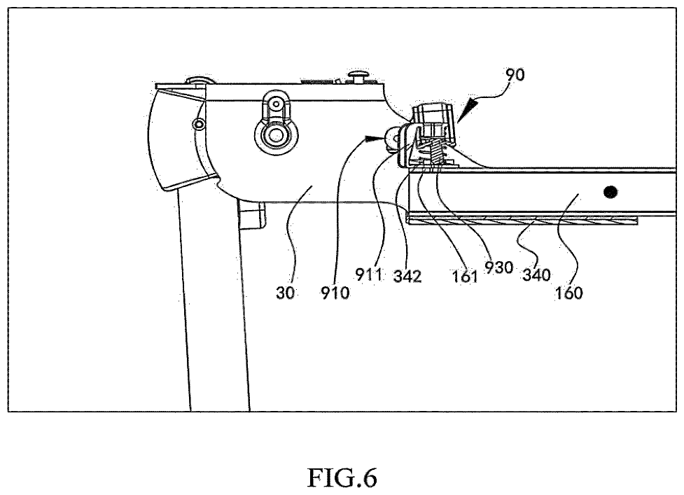

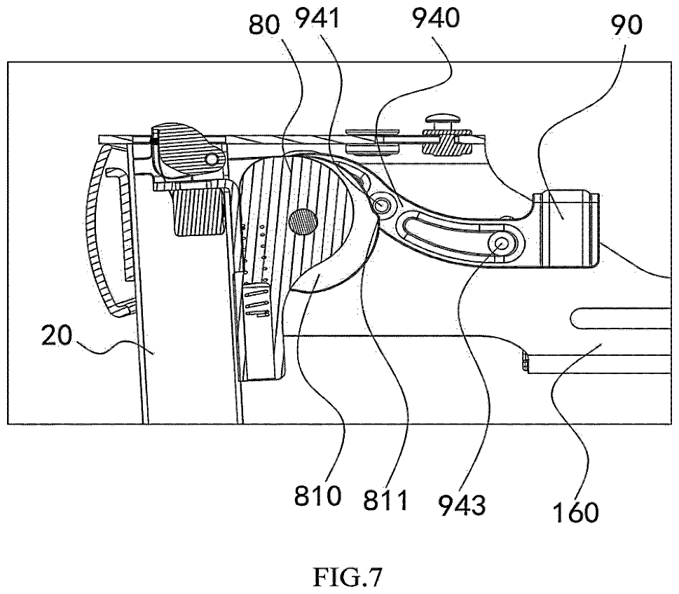

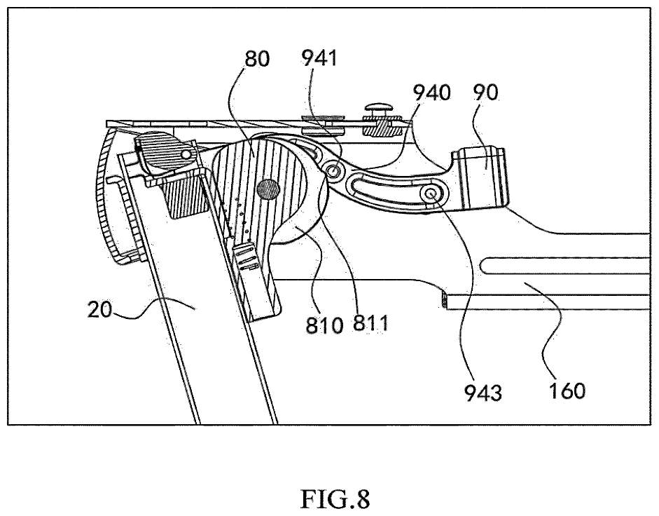

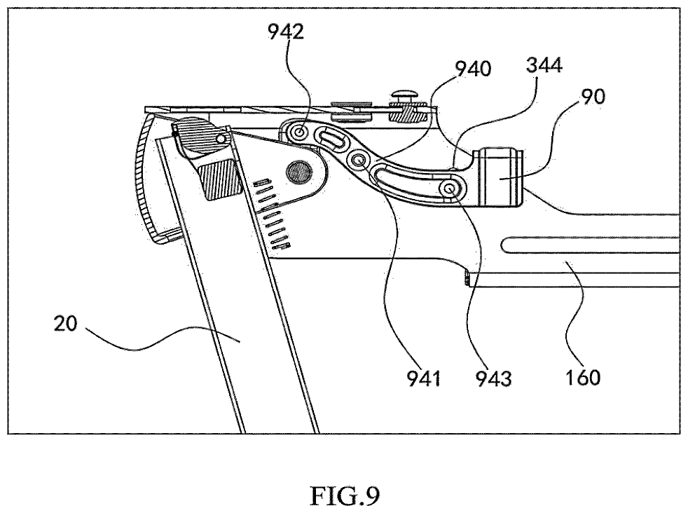

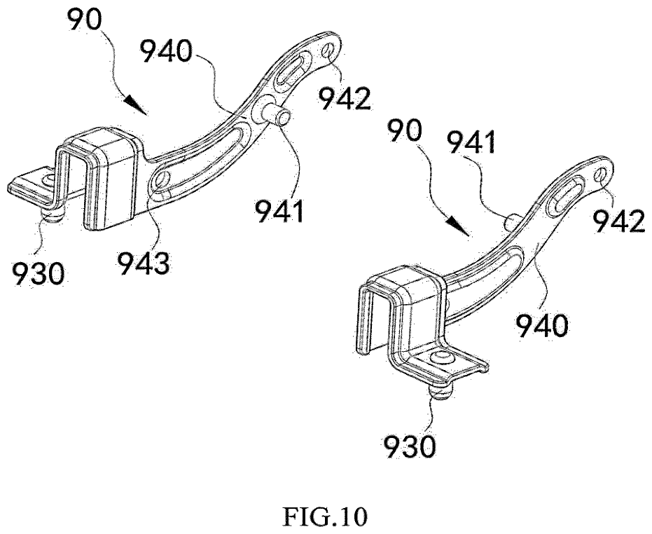

FIG. 4 is a partial top view of a base assembly according to the present application with a part of components removed to show an internal structure. FIG. 5 is a sectional view taken along line C-C of FIG. 4 with a slider in a locked state. FIG. 6 is a sectional view taken along line C-C of FIG. 4 with a slider in an unlocked state. FIG. 7 is a sectional view taken along line B-B of FIG. 4 with a slider in a locked state. FIG. 8 is a sectional view taken along line B-B of FIG. 4 with a slider in an unlocked state. FIG. 9 is a partial cross-sectional view of a base assembly according to the present application with an unlocking member removed. FIG. 10 is a perspective view of two locking members of a base assembly according to the present application.

The base assembly 1 may also include an unlocking member 80 (as shown in FIGS. 7 and 8). The unlocking member 80 may release the locking of the locking member 90 to the slider bracket and the base bracket in response to pivot of the support leg 20 relative to the slider 30 in a first direction. The first direction may be one of a clockwise direction and a counterclockwise direction. As shown in FIG. 5, the first direction may be the counterclockwise direction. It can be understood that when viewed from the other side of the viewing direction shown in FIG. 5, the first direction is correspondingly the clockwise direction.

As shown in FIGS. 6 to 8, the locking member 90 and the unlocking member 80 may both be disposed on the slider 30. The support leg 20 may be connected to the unlocking member 80. For example, the unlocking member 80 may be welded to an upper end of the support leg 20 and rotated with the support leg 20. The unlocking member 80 and the support leg 20 may have the same pivot axis.

Referring to FIGS. 5 and 6, the locking member 90 may include a locking pin 930. The slider bracket 340 may be formed with a locking hole 342. For example, the locking hole 342 may be formed on an upper surface of the slider bracket 340. The base bracket 160 may be formed with a locking hole 161. For example, the locking hole 161 may be formed on an upper surface of the base bracket 160. The bushing 910 may also be formed with a corresponding hole. When the locking hole 342, the locking hole 161 and the corresponding hole of the bushing 910 are aligned, the locking pin 930 may pass through the locking hole 342, the locking hole 161 and the corresponding hole of the bushing 910 to lock the slider bracket 340 to the base bracket 160.

The bushing 910 may have a positioning arm 911. The positioning arm 911 extends substantially vertically upward from a body of the bushing 910 and is bent into a substantially horizontal portion at the end. An elastic member 920 may be fixed below the end of the positioning arm 911 to continuously apply a certain force to the locking pin 930.

The locking member 90 may also include an elastic member 920. The elastic member 920 may be disposed between the locking pin 930 and another portion of the locking member 90 to apply a force to the locking pin 930 toward the locking hole 342. That is, as shown in FIG. 5, the elastic member 920 exerts a downward force on the locking pin 930, and when the locking hole 342, the locking hole 161 and the hole of the bushing 910 are aligned with each other, the locking pin 930 may automatically move downward through the locking hole 342, the locking hole 161 and the hole of the bushing 910. Alternatively, the bushing 910 may not be provided with a hole in the case that the bushing 910 does not cover an area around the locking hole 342.

Referring to FIGS. 7-10, the locking member 90 may include an arm portion 940. The arm portion 940 may extend curvedly from the locking member 90. As shown in FIG. 4 the slider bracket 340 is integrally formed at a front portion (the left side in FIG. 4) and branches into two parallel tubular portions at a rear portion (the right side in FIG. 4) to cooperate with the base bracket 160. A first end of the arm portion 940 (e.g., the right end in FIG. 9) is the locking pin 930, while a second end of the arm portion 940 (e.g., the left end in FIG. 9) may be pivotably connected to the front portion of the slider bracket 340, such that the entire locking member 90 may pivot about the second end. That is, the above-mentioned first and second ends may be opposite ends of the arm portion 940. The arm portion 940 is formed with a convex portion 941 between the first end and the second end. The convex portion 941 may be a cylindrical protrusion that protrudes perpendicular to the arm portion 940.

Referring to FIG. 7 the unlocking member 80 may include a cam 810. A push protrusion 811 projecting radially from the cam 810 may be formed on the cam 810. The cam 810 may have a smaller radius on an upper portion of the push protrusion 811, such that an upper portion of the cam 810 does not push against the convex portion 941 when the cam 810 rotates. The cam 810 may have a larger radius at a lower portion of the push protrusion 811, such that a lower portion of the cam 810 pushes against the convex portion 941 when the cam 810 rotates.

When the support leg 20 pivots relative to the slider 30 in the first direction, the push protrusion 811 may actuate the convex portion, so that the locking member 90 pivots relative to the second end in the first direction, thereby releasing the locking between the slider bracket 340 and the base bracket 160.

Specifically, as shown in FIGS. 6 to 8, when the support leg 20 and the unlocking member 80 are rotated together counterclockwise until the push protrusion 811 contacts the convex portion 941, the push protrusion 811 actuates the convex portion 941 to rotate the unlocking member 90 counterclockwise about its left end, so that the locking pin 930 moves upward to unlock the slider bracket 340 from the base bracket 160. That is, after the support leg 20 is rotated to a certain angle (corresponding to the push protrusion 811), the locking pin 930 may be hold in a position away from the locking holes 342 and 161, such that the slider bracket 340 may be moved relative to the base bracket 160.

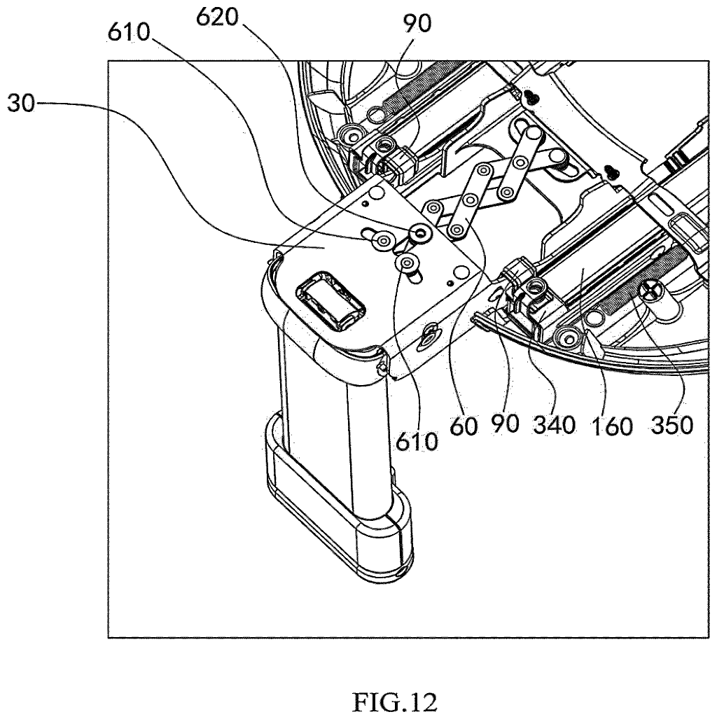

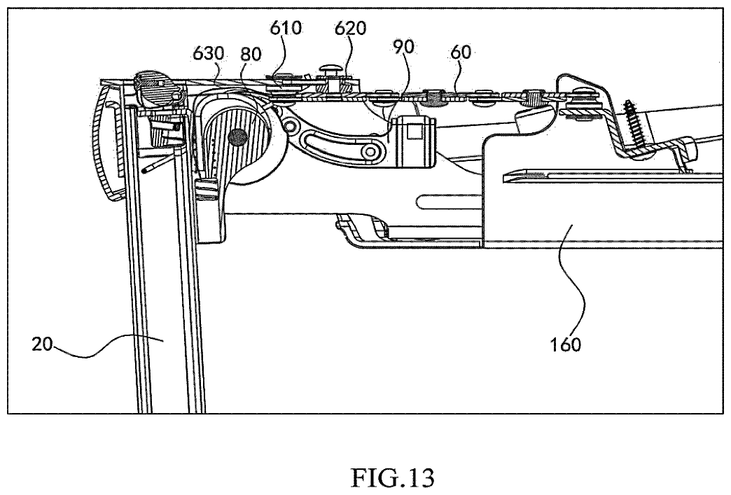

The base assembly 1 may further include a conversion structure 60 (see FIGS. 12 and 13). The specific structure and operation process of the conversion structure 60 will be described in detail below.

Referring to FIGS. 9 and 10, a limiting portion 943 may be formed between both ends of the arm portion 940. The moving distance of the limiting portion 943 relative to the slider bracket 340 may be limited. For example, referring to FIGS. 5 and 9, an arc-shaped groove 344 may be formed on the slider bracket 340 and a hole may be formed at the limiting portion 943. A pin passes through the hole at the limiting portion 943 and the arc-shaped groove 344 on the slider bracket 340, so as to enable the pin to move within a range of the arc-shaped groove 344 (the present application is not limited thereto, and other ways of restricting movement may be used).

As shown in FIGS. 5 and 10, a portion of the locking member 90 at the first end of the arm portion 940 may be formed in a bent shape, so that a portion of the slider bracket 340 may be bypassed while the structural strength of the locking member 90 may be improved. Thus, the convex portion 941 and the locking pin 930 may be located on opposite sides of the arm portion 940.

As shown in FIGS. 5 and 8, the arm of force of the cam 810 pushing against the convex portion 941 may be changed by designing a distance from the convex portion 941 to the second end, thereby adjusting the magnitude of the force required to unlock the slider bracket 340 and the base bracket 160.

In order to realize the telescopic locking when the support leg 20 is in use position, a positioning protrusion/depression may be provided on an upper cover of the slider 30, and a corresponding positioning depression/protrusion may be provided on the base 10, thereby performing concave-convex matching. Thus, when the slider 30 is extended, the above protrusion cooperates with the recess, so as to indicate to the operator that the slider 30 has been extended in place and to prevent the slider 30 from extending further.

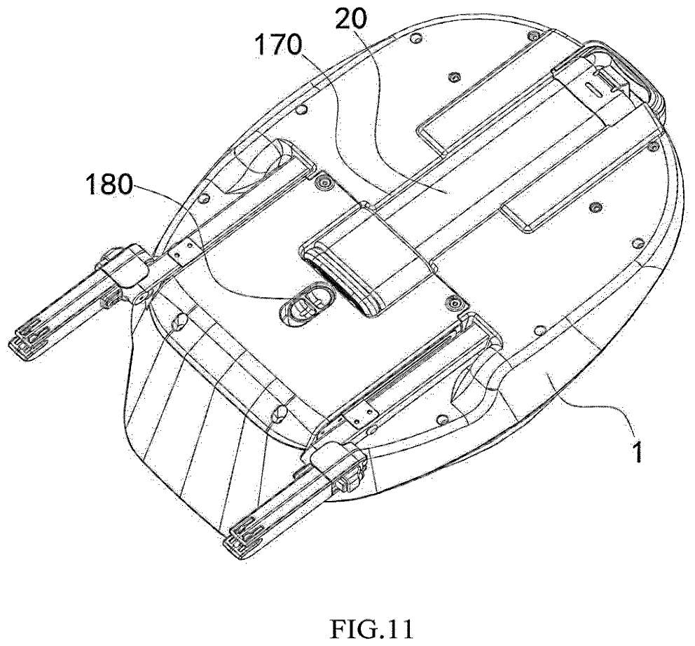

FIG. 11 is a bottom perspective view of a base assembly according to the present application. Referring to FIG. 11, the base 10 may further include a receiving groove 170. When the support leg 20 is folded, it may be received in the receiving groove 170, such that the support leg 20 in the folded state does not protrude from the bottom surface of the base 10, or less protrudes from the bottom surface of the base 10. The base 10 may further include a locking member 180. The locking member 180 may be in the form of a push button movably provided on the bottom surface of the base 10, and may be snapped to lock in one end of the support leg 20 in the receiving groove 170. The locking member 180 may prevent the support leg 20 from accidentally turning out to an unfolded position.

FIG. 12 is a partial perspective view of a base assembly according to another embodiment of the present application with a part of components removed to show an internal structure. FIG. 13 is a partial cross-sectional view of a base assembly according to another embodiment of the present application. In order to avoid repetition, only differences between this embodiment and the previous embodiment will be described below.

Referring to FIGS. 12 and 13, the base assembly 1 may further include a conversion structure 60. The conversion structure 60 may connect the base 10 and the slider 30 at both ends, respectively, and apply a force to the slider 30 toward the base 10 in response to the pivot of the support leg 20 relative to the slider 30 in a first direction. The conversion structure 60 may be directly or indirectly connected to the base 10 and the slider 30. The conversion structure 60 may have a telescopic structure, such as a telescopic structure formed by a plurality of rods pivoted to each other to form a plurality of “X” shaped units (as shown in FIG. 12). The conversion structure 60 may be connected to the support leg 20 via a linkage member 630. The linkage member 630 may be a flexible rope or wire and bypasses the unlocking member 80 (or may bypass another driving member). When the support leg 20 pivots in the first direction, the linkage member 630 actuates the conversion structure 60 by winding the unlocking member 80 so that the conversion structure 60 is shortened, thereby actuating the slider 30 and the support leg 20 together toward the base to shorten the size of the base assembly 1 in a front-back direction. When the support leg 20 pivots in the first direction, a force of the linkage member 630 to actuate the slider 30 is greater than the force required for the locking pin 930 to disengage from a recess 162 (referring to FIGS. 5 and 6), thereby unlocking the slider bracket 340 from the base bracket 160.

The process of shortening the conversion structure 60 described above may be realized in such a way that two ends 610 and a pivot portion 620 may be formed on the conversion structure 60 as shown in FIG. 12. The two ends 610 and the pivot portion 620 are slidably connected to the front portion of the slider bracket 340. Specifically, the two ends 610 may slide substantially in a left-right direction while being restrained in the front-back direction; and the pivot portion 620 may slide in the front-back direction and is restrained in the left-right direction. The linkage member 630 is connected to the pivot portion 620. When the support leg 20 pivots in the first direction, the linkage member 630 pulls the pivot portion 620 forward (to the left side in FIG. 13), thereby moving the pivot portion 620 forward. Since the two ends 610 are restrained from moving forward, the distance between the pivot portion 620 and the two ends 610 is shortened, thereby shortening the conversion structure 60 as a whole.

When the support leg 20 pivots in a second direction (e.g., clockwise direction in FIG. 13) opposite to the first direction, the linkage member 630 no longer exerts force on the conversion structure 60, and the flexible linkage member 630 may be in a slack state. The slider bracket 340 moves relative to the base bracket 160 in a direction extending out of the base assembly 1 under the action of the restoring member 350. In this process, the slider bracket 340 moves with a front end of the conversion structure 60, while a rear end of the conversion structure 60 is directly or indirectly fixed to the base bracket 160, which causes elongation of the conversion structure 60.

Thus, in the present embodiment, only by pivoting the support leg 20, the support leg 20 can be folded or unfolded, and the slider 30 can be translated so as to be fixed or unfixed with the base bracket 160 through the slider bracket 340. That is, the folding or unfolding of the entire base assembly 1 can be completed in only one operation step. The conversion structure 60 may have various forms and is not limited to the forms shown in FIGS. 12 and 13.

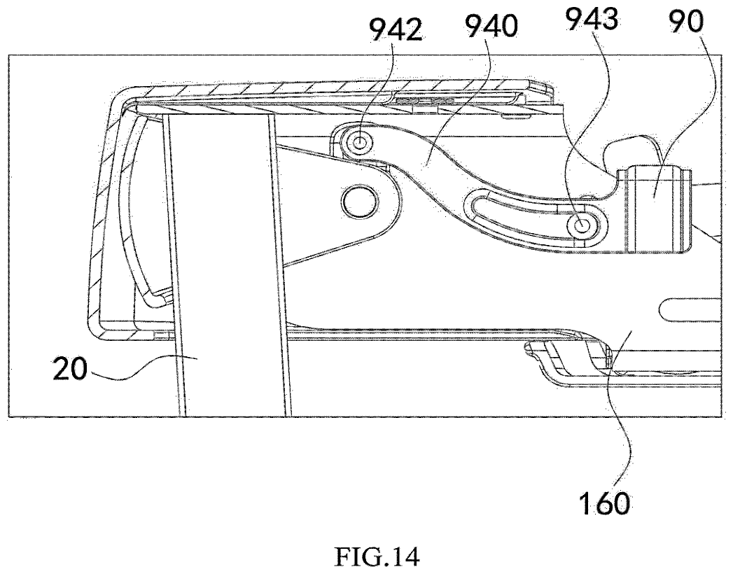

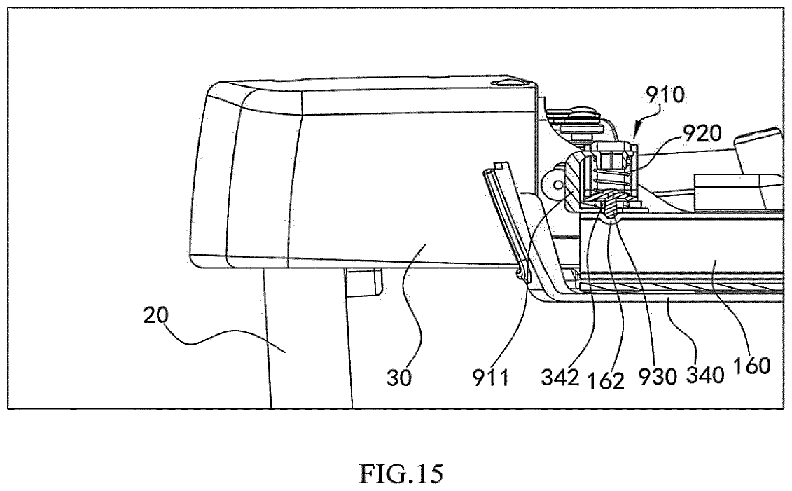

FIG. 14 is a partial cross-sectional view of a base assembly according to another embodiment of the present application, and FIG. 15 is a partial cross-sectional view of a base assembly according to another embodiment of the present application. In order to avoid repetition, only differences between this embodiment and the previous embodiment will be described below.

Referring to FIGS. 14 and 15, in the present embodiment, the base assembly 1 does not have the unlocking member 80. The locking member 90 may include the locking pin 930. The locking member 90 of this embodiment may not have the convex portion 941. The locking member 90 may be fixed to the slider bracket 340. The locking hole 342 may be formed in the slider bracket 340. The recess 162 may be formed on the base bracket 160. The locking pin 930 may pass through the locking hole 342 and enter the recess 162 to lock the slider bracket 340 to the base bracket 160.

The recess 162 may be formed such that the locking pin 930 may be disengaged from the recess 162 when the slider bracket 340 is pushed relative to the base bracket 160 with a force exceeding a threshold value, thereby unlocking the slider bracket 340 from the base bracket 160.

The recess 162 may be formed as a spherical groove, and one end of the locking pin 930 may be formed with a shape matching the spherical groove, so that the spherical groove may play a guiding role when the locking pin 930 is pushed. It can be understood that the recess 162 may also be formed in another shape and the present application is not limited thereto.

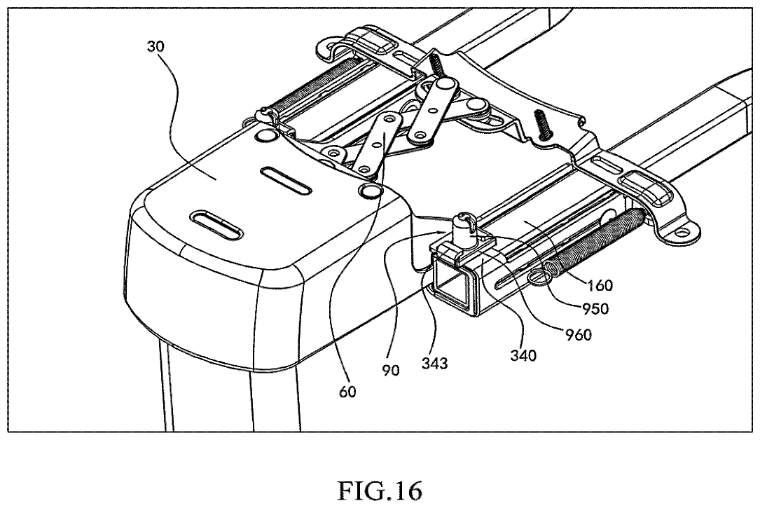

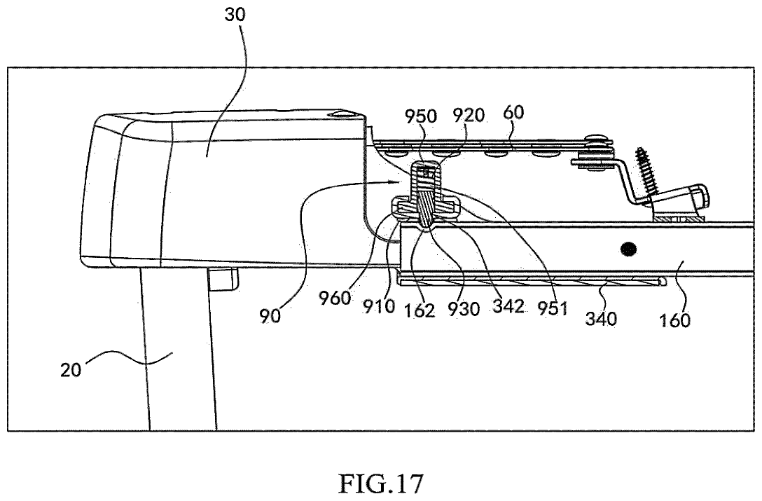

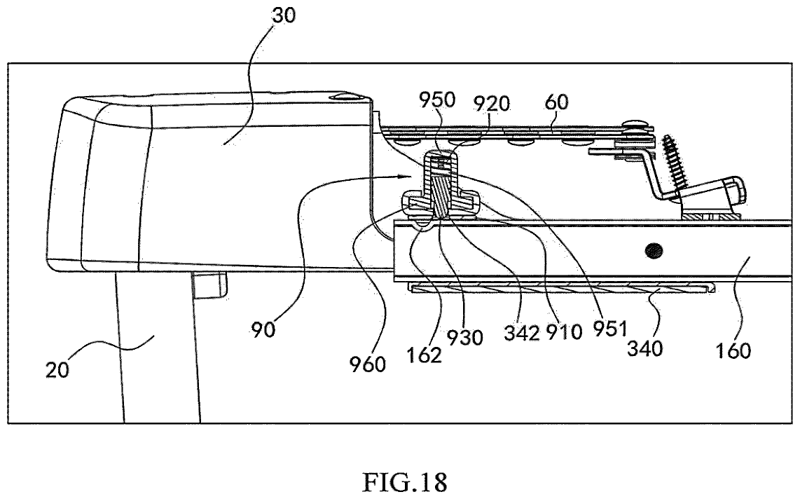

FIG. 16 is a partial perspective view of a base assembly according to another embodiment of the present application. FIG. 17 is a partial cross-sectional view of a base assembly according to another embodiment of the present application with a slider in a locked state. FIG. 18 is a partial cross-sectional view of a base assembly according to another embodiment of the present application with a slider in an unlocked state. In order to avoid repetition, only differences between this embodiment and the previous embodiment will be described below.

Referring to FIGS. 16-18, in the present embodiment, the base assembly 1 does not have the unlocking member 80. The locking member 90 of the present embodiment may not include the arm portion 940, but may include the elastic member 920, the locking pin 930, a fixing cover 950, and a fixing seat 960. The bushing 910 of this embodiment may not include the positioning arm 911.

The interior of the fixing cover 950 may be formed as a chamber 951 to receive the elastic member 920 and the locking pin 930 therein. An opening may be formed below the fixing cover 950 to allow the locking pin 930 to extend out partially. The chamber 951 inside the fixing cover 950 may be formed in a generally cylindrical shape, but the present application is not limited thereto. The chamber 951 inside the fixing cover 950 may also be formed in a prismatic shape.

The locking pin 930 may be shaped to match the chamber 951 inside the fixing cover 950, so that it may be guided by the chamber 951 to linearly move downward. An upper portion of the locking pin 930 may be larger in size than the opening below the fixing cover 950, and a lower portion of the locking pin 930 may be smaller in size than the opening below the fixing cover 950, so that the locking pin 930 may only partially project out of the opening without fully disengaging from the fixing cover 950.

The fixing seat 960 may be formed as a plate-like member extending transversely from the bottom of the fixing cover 950. The fixing seat 960 may be integrally formed with the fixing cover 950. Alternatively, the fixing seat 960 and the fixing cover 950 may be formed separately and connected to each other. The fixing seat 960 may be formed as a rectangle, but this application is not limited thereto. The slider bracket 340 may include a fixing portion 343. The fixing portion 343 extends upward from both sides above the slider bracket 340 and then bend inward to form a certain space (chute). The fixing seat 960 may be inserted and fixed in the space (chute) in a horizontal direction, so that the locking member 90 is fixed above the slider bracket 340. The fixing seat 960 may also be removed from the slider bracket 340 by moving in the horizontal direction. It will be appreciated that the fixing seat 960 may also be fixed to the slider bracket 340 in other known ways. Since the slider bracket 340 branches into two parallel tubular portions at the rear (the right side in FIG. 17), the two locking members 90 may be respectively fixed to the two parallel tubular portions (as shown in FIG. 16).

The elastic member 920 may be disposed within the chamber 951 and abuts against the upper portion of the locking pin 930, thereby maintaining a downward force on the locking pin 930.

The base assembly 1 may further include the conversion structure 60. The conversion structure 60 may connect the base 10 and the slider 30 at both ends, respectively, and apply a force to the slider 30 toward the base 10 in response to the pivot of the support leg 20 relative to the slider 30 in the first direction (e.g., counterclockwise in FIG. 13). The conversion structure 60 may be directly or indirectly connected to the base 10 and the slider 30. The conversion structure 60 may have a telescopic structure, such as a telescopic structure formed by a plurality of rods pivoted to each other to form a plurality of “X” shaped units (as shown in FIG. 12). The conversion structure 60 may be connected to the support leg 20 via the linkage member 630. The linkage member 630 may be a flexible rope or wire and bypasses the unlocking member 80 (or may bypass another driving member). When the support leg 20 pivots in the first direction, the linkage member 630 actuates the conversion structure 60 by winding the unlocking member 80 so that the conversion structure 60 is shortened, thereby actuating the slider 30 and the support leg 20 together toward the base to shorten the size of the base assembly 1 in the front-back direction (the expansion and contraction process of the conversion structure 60 may be known from the previous embodiment). When the support leg 20 pivots in the first direction, the force of the linkage member 630 to actuate the slider 30 is greater than the force required for the locking pin 930 to disengage from the recess 162, thereby unlocking the slider bracket 340 from the base bracket 160.

When the support leg 20 pivots in the second direction (e.g., clockwise direction in FIG. 13) opposite to the first direction, the linkage member 630 no longer exerts force on the conversion structure 60, and the flexible linkage member 630 may be in a slack state. The slider bracket 340 moves relative to the base bracket 160 in a direction extending out of the base assembly 1 under the action of the restoring member 350. In this process, the slider bracket 340 moves with the front end of the conversion structure 60, while the rear end of the conversion structure 60 is directly or indirectly fixed to the base bracket 160, which causes elongation of the conversion structure 60.

Thus, in the present embodiment, only by pivoting the support leg 20, the support leg 20 can be folded or unfolded, and the slider 30 can be translated so as to be fixed or unfixed with the base bracket 160 through the slider bracket 340. That is, the folding or unfolding of the entire base assembly 1 can be completed in only one operation step.

When the support leg 20 pivots, the linkage member 630 pulls the conversion structure 60 so that the conversion structure 60 is shortened, thereby pulling the slider 30 and the support leg 20 together toward the base to shorten the size of the base assembly 1 in the front-back direction. When the support leg 20 pivots, the force of the linkage member 630 pulling the slider 30 is greater than the force required for the locking pin 930 to disengage from the recess 162. That is to say, in the present embodiment, only by pivoting the support leg 20, the support leg 20 can be folded or unfolded, and the slider 30 can be translated to release the slider bracket 340 from the base bracket 160. In this way, the folding or unfolding of the entire base assembly 1 can be completed in only one operation step.

The present application also provides a base assembly, which has reliable locking effect of its support leg and convenient for unfolding and folding, and a child safety seat. The present application provides a base assembly 1 and a child safety seat including the base assembly 1. The child safety seat may be installed on a seat of a car for infants or children to seat and ensure the safety of the passenger.

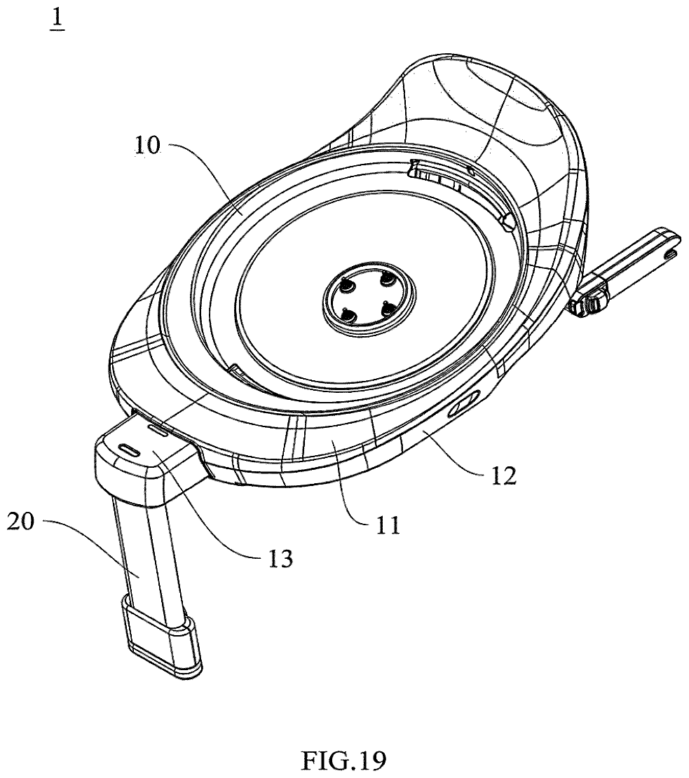

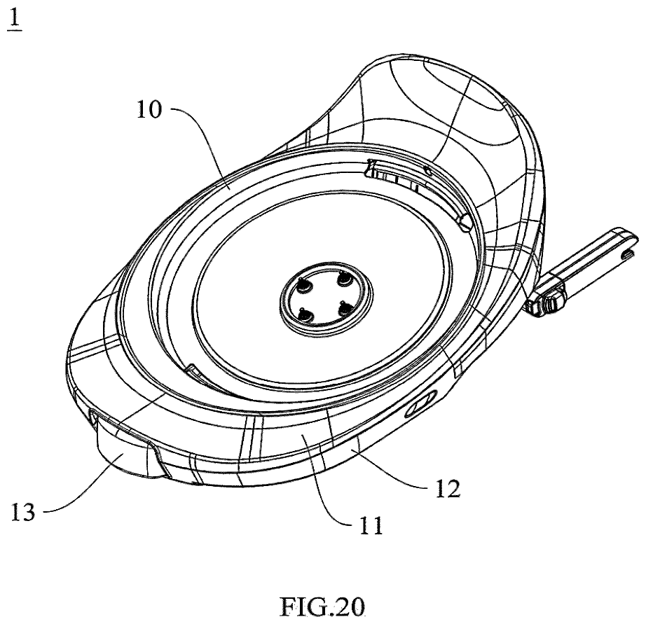

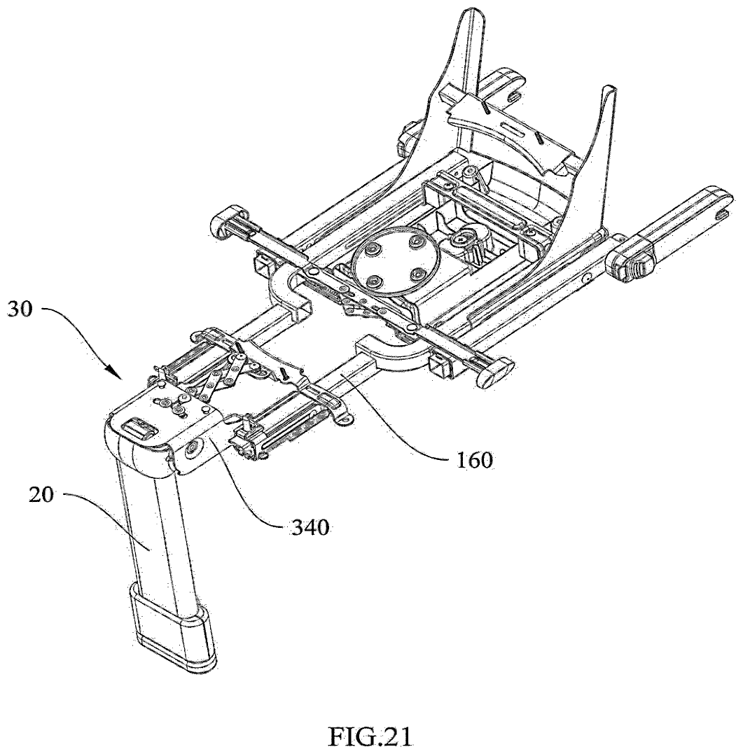

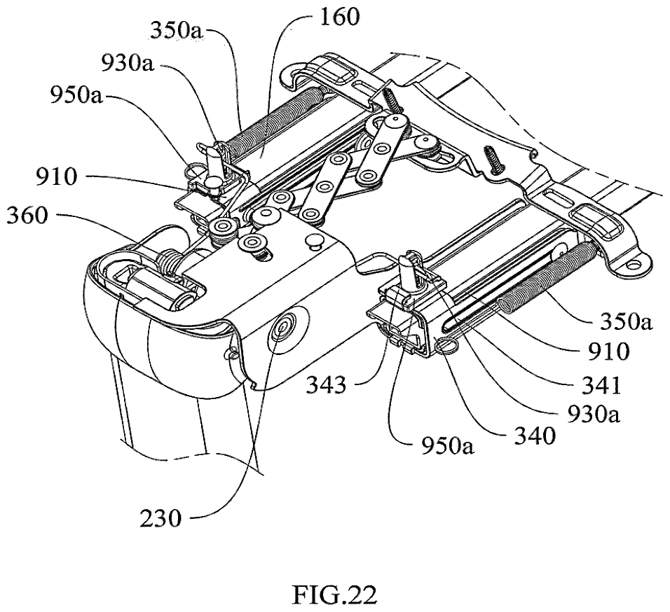

FIG. 19 is a perspective view of a base assembly according to the present application with a support leg in an unfolded position. FIG. 20 is a perspective view of a base assembly according to the present application with a support leg in a folded position. FIG. 21 is a perspective view of a base assembly according to the present application with a part of components removed to show an internal structure of the base assembly. FIG. 22 is a partial perspective view of an internal structure of a base assembly according to the present application, wherein a locking member covers a locking hole.

Referring to FIGS. 19-22, a child safety seat may have a base assembly 1 and a seat (not shown). The base assembly 1 may have a base 10, a support leg 20, a slider 30, a driving member 360, and a locking structure. The seat may be disposed rotatably on the base 10 and may have at least one forward position and one backward position. The forward position may be a position in which the seat faces the front of a vehicle, and the backward position may be a position in which the seat faces the rear of the vehicle. The forward position may for example be applicable to older children and the backward position may for example be applicable to younger infants, but the present application is not limited thereto.

The support leg 20 is pivotably and telescopically disposed on the base 10. The slider 30 is disposed slidably on the base 10. The support leg 20 may be pivotably connected to the slider 30 by means of a pivot 230 and moves telescopically with the slider 30 relative to the base 10. The pivot 230 may be disposed at the front of the slider 30 and may be moved with the slider 30. When the support leg 20 is used, the support leg 20 may extend out of the base 10 and turn out to touch the ground (as shown in FIG. 19), thus preventing the child safety seat from overturning during impact. When the support leg 20 is not used, the support leg 20 can be synchronously rotated and contracted to the bottom of the base 10 (as shown in FIG. 20). In this way, the overall size of the child safety seat may be reduced, so that it is convenient to store and use.

The base 10 may include a base upper cover 11, a base lower cover 12, and a decorative cover 13. The base upper cover 11 and the base lower cover 12 are combined with each other from above and below to define an internal space of the base 10. A notch is formed in front of the base upper cover 11 and the base lower cover 12 which are combined with each other, and the notch allows telescopic movement of the slider 30 relative to the base 10. The decorative cover 13 is arranged at the notch and moves with the slider 30. The decorative cover 13 may block the notch without directly exposing the internal structure of the base 10.

The base 10 may further include a base bracket 160. The base bracket 160 may be located in the internal space defined by the base upper cover 11 and the base lower cover 12. The slider 30 may include a slider bracket 340 and an elastic member 350a. Alternatively, the elastic member 350a is a restoring member. The slider bracket 340 may have a symmetrical structure. A front portion of the slider bracket 340 may be disposed inside the decorative cover. A rear portion of the slider bracket 340 is slidably sleeved on the base bracket 160. The rear portion of the slider bracket 340 may extend rearward from the front portion of the slider bracket 340 to form a two-arm structure. The locking structure may be responsive to pivot of the support leg 20 to which the driving member is connected, so as to selectively lock or unlock the slider bracket 340 with the base bracket 160.

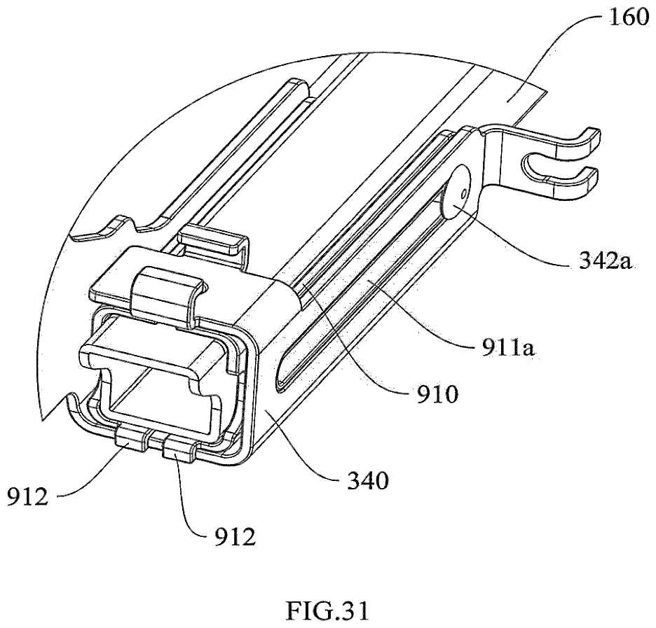

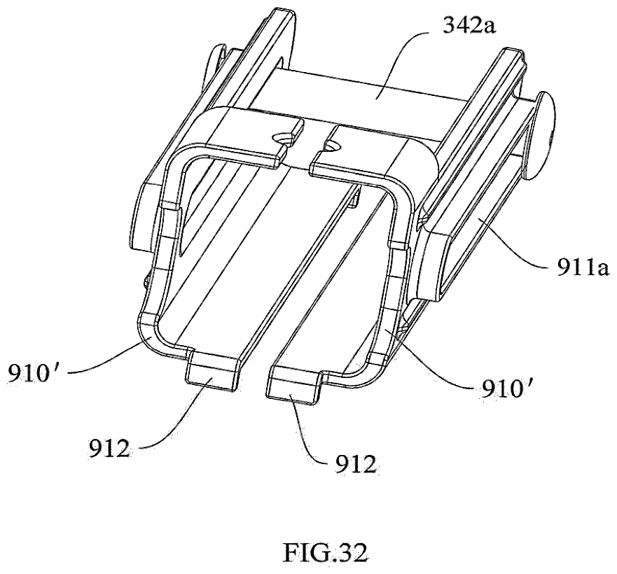

The base bracket 160 may be used as a carrier to bear the main weight of the base assembly 1. The slider bracket 340 may be sleeved on the base bracket 160. Each of the base bracket 160 and the slider bracket 340 may be symmetrically formed on both sides of the base assembly 1, but the present application is not limited thereto. A slider groove 341 may be provided on the slider bracket 340 to limit a distance of movement of the slider bracket 340 relative to the base bracket 160 by, for example, a slider rod 342a (see FIGS. 31 and 32). The slider rod 342a may be a pin. Alternatively, the slider groove 341 may also be formed on the base bracket 160. Both ends of the elastic member 350a may be connected to the base 10 and the slider bracket 340 for applying an elastic force therebetween. Specifically, both ends of the elastic member 350a may be connected between a fixed shaft 122 on the base lower cover 12 and the slider bracket 340. Alternatively, the elastic member 350a may be formed between the base upper cover 11 and the slider bracket 340. The elastic member 350a may apply a force to the slider bracket 340 to move the slider bracket 340 in a direction extending out of the base assembly 1, thereby realizing automatic extension out of the slider bracket 340.

A bushing 910 may be disposed between the base 10 and the slider 30. In one embodiment, the bushing 910 may be provided between the base bracket 160 and the slider bracket 340. The bushing 910 may make the sliding between the base bracket 160 and the slider bracket 340 smoother. The bushing 910 may be attached to the slider bracket 340 for movement with the slider bracket 340. The bushing 910 may be formed by connecting two plastic blocks, but the present application is not limited thereto.

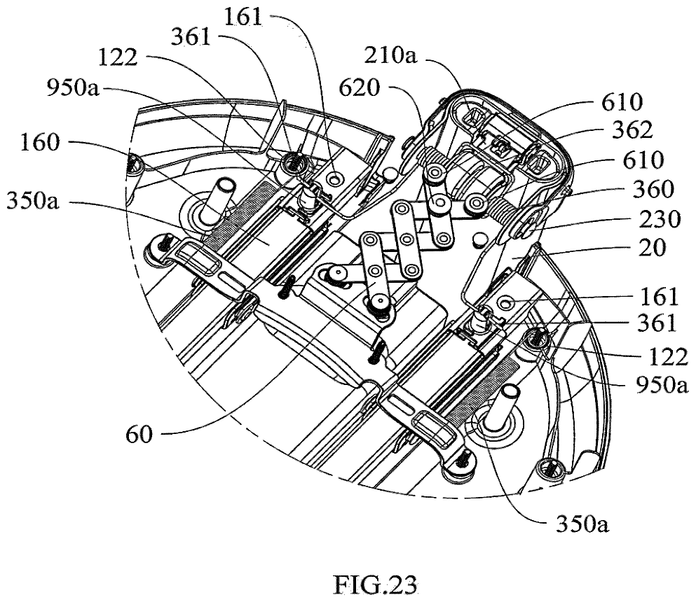

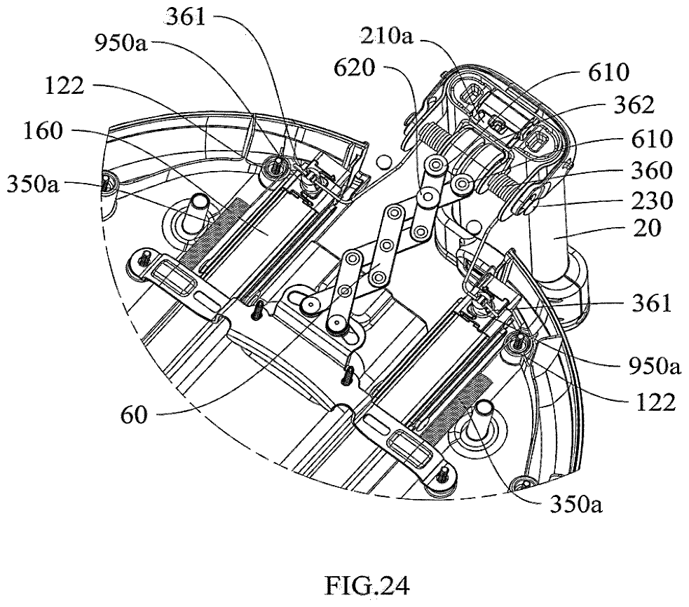

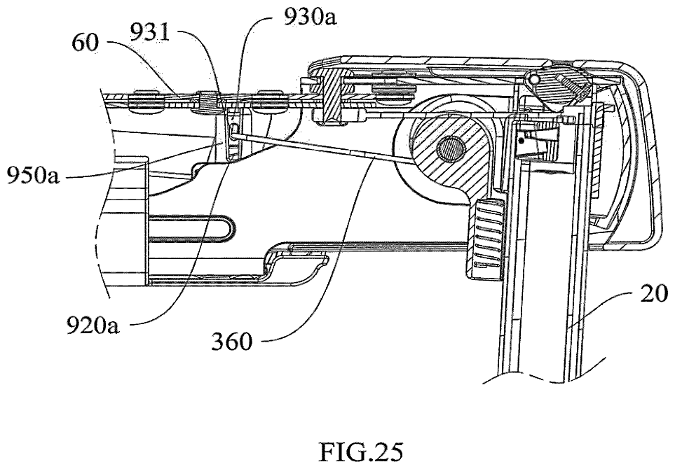

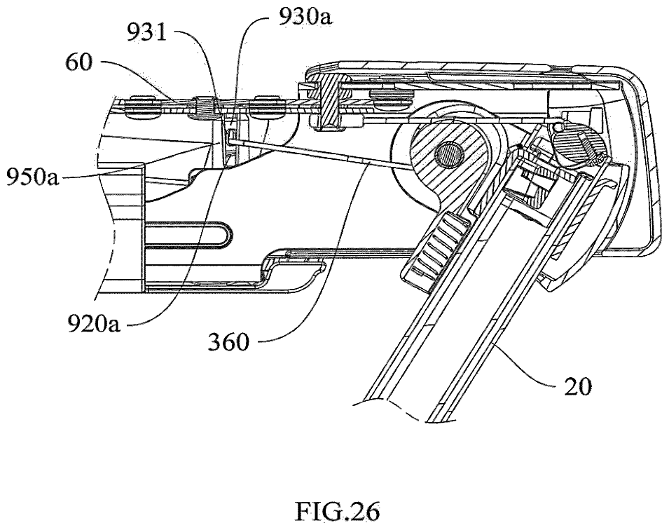

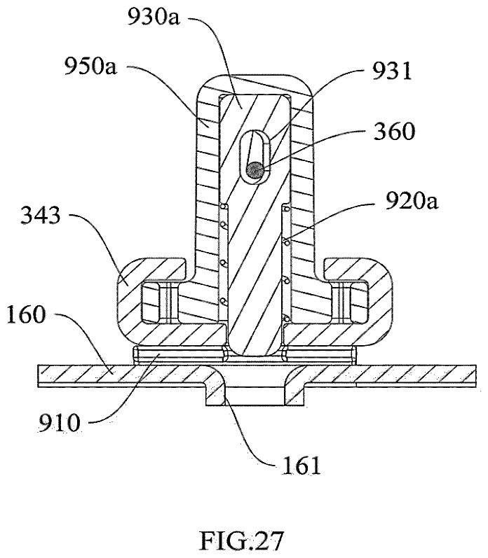

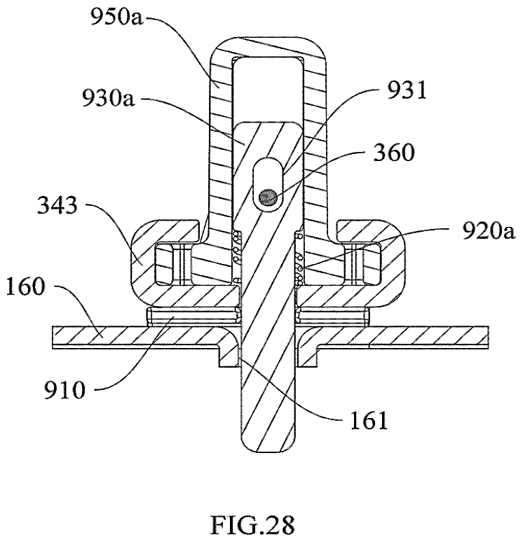

FIG. 23 is a partial perspective view of an internal structure of a base assembly according to the present application from another perspective, wherein a locking member is deviated from a locking hole. FIG. 24 is a partial perspective view of an internal structure of a base assembly according to the present application from another perspective, wherein a locking member covers a locking hole. FIG. 25 is a partial cross-sectional view of a base assembly according to the present application with a support leg proximate an unfolded position. FIG. 26 is a partial cross-sectional view of a base assembly according to the present application with a support leg proximate a folded position. FIG. 27 is a partial cross-sectional view of a base assembly according to the present application with a locking member not inserted into a locking hole. FIG. 28 is a partial cross-sectional view of a base assembly according to the present application with a locking member inserted into a locking hole.

Referring to FIGS. 25 to 27, the locking structure may include a locking member 930a. Alternatively, the locking structure may be formed as the locking member 930a. The locking member 930a may be disposed on the slider 30 (as shown in FIG. 21). In another embodiment, the locking member 930a may be disposed in another location. For example, the locking member may be disposed on an arm portion (not shown) pivotally connected to the slider 30. Alternatively, the locking member 930a is a locking pin (see FIG. 27 for detail). The locking member 930a may be formed as a pin. The base 10 may include a locking hole 161 (see FIG. 27 for detail). Specifically, the locking hole 161 may be disposed on an upper surface of the base bracket 160. The locking structure may lock the slider 30 with the base 10 by inserting the locking member 930a into the locking hole 161. An upper surface of the base bracket 160 may be provided with a mounting seat 950a for accommodating the locking member 930a. Alternatively, the mounting seat 950a is a fixing cover. The mounting seat 950a may restrict the locking member 930a, such that the locking member 930a may be moved only in an up-down direction.

Referring to FIG. 22, the slider bracket 340 may include a fixing portion 343. The fixing portion 343 extends upward from the front and rear sides above the slider bracket 340 respectively and then are bent inward to form a certain space (chute). This space may be used to accommodate the mounting seat 950a.

A reset member 920a may be arranged below the locking member 930a (as shown in FIG. 27). Alternatively, the reset member 920a is an elastic member. A lower end of the reset member 920a may abut against the mounting seat 950a and an upper end of the reset member 920a may abut against the locking member 930a. The reset member 920a may apply pressure to the locking member 930a in a direction that causes the locking member 930a to leave the locking hole 161 (i.e., an upward direction in FIG. 27). The reset member 920a maintains applying pressure to the locking member 930a to realize the function of automatic unlocking. The reset member 920a may be a helical spring, but the present application is not limited thereto.

Referring to FIGS. 23 and 24, the locking structure may include the driving member 360. The driving member 360 is located between the base upper cover 11 (as shown in FIG. 20) and the base bracket 160. The driving member 360 may be a torsion spring and is provided at the front of the slider 30. Specifically, the driving member 360 may be sleeved on the pivot 230. The driving member 360 may include a first end 361 and a second end 362. The first end 361 may be connected to the locking member 930a. The second end 362 may abut against the support leg 20. The support leg 20 may have a rotation support 210a. One end of the rotation support 210a is sleeved on the pivot 230 and may pivot about the pivot 230. When the support leg 20 is extended out, the rotation support 210a presses against the second end 362 to achieve a buffering effect.

The first end 361 extends and passes through the mounting seat 950a and the locking member 930a. The locking member 930a may be formed with a through hole 931 (as shown in FIGS. 26 and 27) through which the first end 361 passes. The through hole 931 may be formed in an elongated shape, that is, the through hole 931 extends a certain length in a vertical direction. The first end 361 may be formed with an elastic barb having a vertical dimension which may be slightly larger than that of the through hole 931. Further, when the first end 361 passes through the through hole 931, it is folded back to form a U-shaped elastic barb, or before the first end 361 passes through the through hole 931, the elastic barb is formed first, then the elastic barb is pressed to be elastically deformed so as to pass through the through hole 931, and then the elastic barb is released, so that the elastic barb cannot be detached from the through hole 931. After the first end 361 passes through the through hole 931, the elastic barb is blocked by the through hole 931 and cannot be detached from the through hole 931. The first end 361 may also be formed as another structure to prevent detachment from the through hole 931.

When the support leg 20 is pivoted, the second end 362 is pressed by the rotation support 210a, thereby pushing the second end 362 to bias the first end against the locking member 930a. The rotation support 210a may press against the second end 362 when the support leg 20 is rotated at an angle from the folded position to the unfolded position. For example, the angle may be an included angle of 60° with the folded position. The angle may be an included angle of 45°, 50°, 55°, 60°, 65°, 70°, 75°, 80°, 85°, 90°, or the like, with the folded position. The application does not limit the specific value of the angle. The locking member 930a is inserted into the locking hole 161 when the support leg 20 is fully opened, that is, when the support leg 20 is rotated at an angle in the range of 87° to 90° from the folded position to the unfolded position.

During the rotation of the support leg 20 from the folded position to the unfolded position, the rotation support 210a pushes the second end 362 upwards and the first end 361 moves downwards accordingly. When pressure applied by the first end 361 to the locking member 930a is greater than pressure applied by the reset member 920a to the locking member 930a, the locking member 930a tends to move downward (i.e., in a direction of insertion into the locking hole 161). At this time, if the locking member 930a is not aligned with the locking hole 161 (as shown in FIG. 23), the locking member 930a abuts against the upper surface of the base bracket 160. When the support leg 20 is further rotated while the slider 30 continues to move forward until the locking member 930a is aligned with the locking hole 161 (as shown in FIG. 24), the locking member 930a moves downward and passes through the locking hole 161, thereby locking the slider bracket 340 with the base bracket 160 (as shown in FIG. 28).

The support leg 20 may be arranged so that it may be automatically unfolded after being unlocked. The support leg 20 may also be arranged to be manually unfolded. The driving member 360 may both provide a buffer to the support leg 20 when the support leg 20 is unfolded, and may apply pressure to the locking member 930a in response to pivot of the support leg 20, in order to achieve a locking function.

During the rotation of the support leg 20 from the unfolded position to the folded position, pressure exerted by the rotation support 210a on the second end 362 is gradually reduced. Accordingly, the pressure exerted by the first end 361 on the locking member 930a is also gradually reduced. When the pressure applied by the first end 361 to the locking member 930a is less than the pressure applied by the reset member 920a to the locking member 930a, the locking member 930a moves upward (i.e., in a direction away from the locking hole 161), thereby unlocking the slider bracket 340 from the base bracket 160. After the slider bracket 340 is unlocked from the base bracket 160, the slider bracket 340 is movable relative to the base bracket 160.

As shown in FIGS. 23 and 24, the driving member 360 may be symmetrical and have two first ends 361 and one second end 362. The two first ends 361 may be connected to the two locking members 930a, respectively. However, in other embodiments, the driving member 360 may have one first end 361 and one second end 362. For example, the base assembly 1 may have two driving members 360 disposed symmetrically. The base assembly 1 may also have one locking member 930a and one driving member 360.

The base assembly 1 may further include a conversion structure 60. The conversion structure 60 may connect the base 10 and the slider 30 at both ends, respectively, and applies a force toward the front (right side in FIG. 25) to the slider 30 in response to the pivot of the support leg 20 from the folded position to the unfolded position. The conversion structure 60 may be directly or indirectly connected to the base 10 and the slider 30. The conversion structure 60 may have a telescopic structure, such as a telescopic structure formed by a plurality of rods pivoted to each other to form a plurality of “X” shaped units (as shown in FIGS. 23 and 24). The conversion structure 60 may be connected to the support leg 20 via a linkage member (not shown). The linkage member may be a flexible rope or wire.

The process of shortening the conversion structure 60 described above may be realized in such a way that two ends 610 and a pivot portion 620 may be formed on the conversion structure 60. The two ends 610 and the pivot portion 620 are all slidably connected to the front portion of the slider bracket 340. Specifically, the two ends 610 may slide substantially in a left-right direction while being restrained in the front-back direction; and the pivot portion 620 may slide in the front-back direction and is restrained in the left-right direction. The linkage member is connected to the pivot portion 620. When the support leg 20 pivots from the folded position to the unfolded position, the linkage member pulls the pivot portion 620 forward (right side in FIG. 25), thereby moving the pivot portion 620 forward. Since the two ends 610 are restrained from moving forward of the base 10, the distance between the pivot portion 620 and the two ends 610 is shortened, thereby shortening the conversion structure 60 as a whole.

When the support leg 20 pivots from the unfolded position to the folded position, the linkage member no longer exerts force on the conversion structure 60, and the flexible linkage member is in a slack state. The slider bracket 340 moves rearward with respect to the base bracket 160 under the action of the elastic member 350a. In this process, the slider bracket 340 moves with a front end of the conversion structure 60, while a rear end of the conversion structure 60 is directly or indirectly fixed to the base bracket 160, which causes the conversion structure 60 to be shortened.

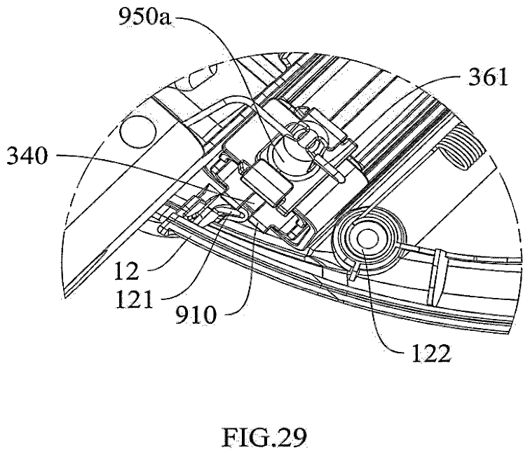

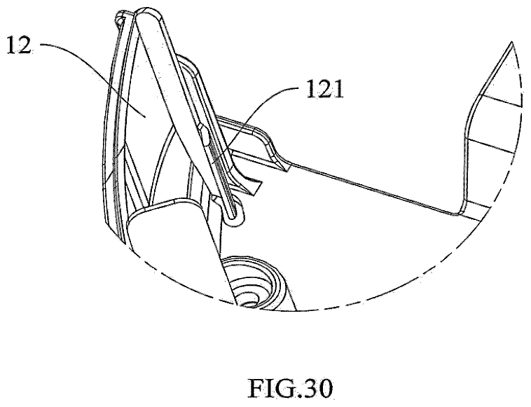

FIG. 29 is a partial perspective view of an internal structure of a base assembly according to the present application; and FIG. 30 is a partial perspective view of an internal structure of a base assembly according to the present application.

A buffer 121 may be disposed on the base lower cover 12. The buffer 121 may be formed as a buffer rib. The buffer 121 may also be formed in other forms having a buffering function. The buffer 121 may be formed of a material such as soft glue, foam, or the like. The buffer rib is elastic and may be suspended on the base lower cover 12. When the slider 30 moves toward the base 10, it may abut against the buffer 121, thereby being buffered. This prevents noise from the slider bracket 340 and/or the bushing 910 striking the base lower cover 12 when the support leg 20 is unfolded.

In the present application, the driving member 360 is sleeved on the pivot shaft 230 for biasing the locking member 930a to lock and fit with the locking hole 161 on the base bracket 160. The first end 361 of the driving member 360 is connected with the locking member 930a, the second end 362 thereof is pressed against the support leg 20, and the reset member 920a for pushing the locking member 930a upward is provided. Thus, when the support leg 20 is extended but not pivoted, the locking member 930a is not inserted into the locking hole 161 due to the elastic force of the reset member 920a. When the support leg 20 is pivoted outwardly, the support leg 20 presses against the second end 362 of the driving member 360, so that the first end 361 overcomes the elastic force of the reset member 920a and is inserted into the locking hole 161 to lock the slider bracket 340 to the base bracket 160. When the support leg 20 is folded, pivoting the support leg 20 inward releases torsion of the first end 361 of the driving member 360. The locking member 930a may disengage from the locking hole 161 under the action of the reset member 920a to release the locking between the slider bracket 340 and the base bracket 160.

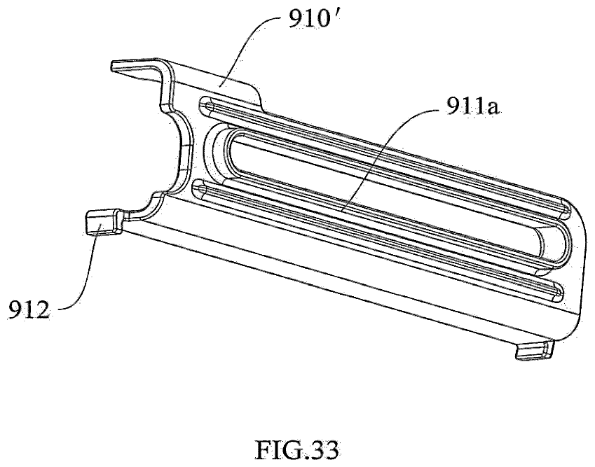

FIG. 31 is a partial perspective view of an internal structure of a base assembly according to the present application. FIG. 32 is a perspective view of a bushing of a base assembly according to the present application. FIG. 33 is a perspective view of a portion of a bushing of a base assembly according to the present application.

The bushing 910 may be made of a wear-resistant and smooth plastic material. The bushing 910 may be formed with an annular rib 911a and a hook 912. The annular rib 911a may be disposed on a side of the bushing 910. The annular rib 911a may extend into the slider groove 341 (as shown in FIG. 22) to avoid direct friction between the slider rod 342a and the slider bracket 340. The hook 912 may be formed at a front end and a rear end of the bushing 910. The hook 912 may be engaged on the slider bracket 340 by its deformation fit or interference fit. In addition, the hook 912 located on the front end acts with the buffer 121 on the base 10 to achieve a buffering effect.

The bushing 910 may include two bushing half bodies 910′. The two bushing half bodies 910′ are symmetrical with each other. Each of the bushing half bodies 910′ may respectively have the rib 911 and hook 912 as described above.

As shown in FIG. 32, the bushing 910 is made of wear-resistant and smooth plastic, ceramic, metal or other smooth and wear-resistant material, and is formed by butting two pieces, and is engaged on the slider bracket 340 through the front and rear hooks 912, respectively. Thus, a sliding gap between the bushing 910 and the base bracket 160 can be well ensured, and smooth sliding and low noise can be ensured. During assembly, the assembly can be quickly completed by the deformation of the hook 912, which is convenient for production and assembly.

The present application has at least one of the following advantages:

1. In this application, the slider and the base may be locked by the locking member, such that the support leg plays a stable supporting role when unfolding. Especially in use, children's feet may kick the slider intentionally or unintentionally. If the kick force is too large, the slider may retract into the base. Under the action of the locking member, it is possible to prevent the slider from retracting into the base, which causes the support foot to fail to play a supporting role, and thus ensuring the supporting stability of the support leg and further ensuring the use safety of the child safety seat.

2. The sliding between the slider and the base is stable and smooth because of the slider bracket and the base bracket, and the structural strength of the child safety seat is improved.

3. The slider bracket and the base bracket may be unlocked while pivoting the support leg by the unlocking member, so that the pivoting and translation of the support leg can be carried out so as to achieve the purpose of the folding or unfolding of the support leg through one action.

4. Since the locking member and the unlocking member are both arranged on the slider, it is not necessary to provide a separate supporting structure to support the locking member and the unlocking member.

5. The slider bracket and the base bracket may slide more smoothly relative to each other by arranging the bushing.

6. The locking and unlocking of the slider bracket and the base bracket may be conveniently and reliably controlled by the locking pin or the locking member.

7. The bushing may promote sliding between the slider bracket and the base bracket, and the hole in the bushing enables the locking pin or the locking member to pass through the bushing to realize locking and unlocking.

8. By providing the recess on the base bracket, the slider bracket and the base bracket may be directly unlocked by applying a force exceeding a threshold value, and other unlocking structures can be omitted, so that the structure is simpler.

9. The unlocking and locking process of slider bracket and base bracket may run stably through the cooperation of the cam and the convex portion, and the unlocking and locking process may not exert excessive resistance to the pivot of the support leg, and the specific positions of the unlocking and locking may be adjusted according to needs.

10. By disposing the limiting portion, the moving range of the locking member is limited, so that the unlocking and locking process between the slider bracket and the base bracket is more stable, and the shaking of the locking member is avoided.

11. The elastic member or the restoring member enables the locking pin or the locking member to move spontaneously towards the locking position, so that no additional operation of the locking pin or the locking member is required during the locking process.

12. By disposing the receiving groove, the support leg may not protrude out of the base after being folded, thus saving space.

13. By disposing the conversion structure, the processes such as the pivot and translation of the support leg and the unlocking of the locking member can be integrated into one process, thus saving the operation steps.

14. When the support leg of the present invention is extended and pivoted outward (unfolded) in place, the locking can be well performed. Furthermore, when the support leg is contracted and folded, the support leg can be conveniently and quickly contracted and folded.

15. By arranging the locking structure of the present application, when the support leg is extended and pivoted in place, the support leg can be well locked, and the support leg is prevented from being unexpectedly retracted due to locking failure caused by external force collision, so as to ensure the supporting effect and stability of the support leg. When the support leg is contracted and folded, the support leg can be retracted only by pivoting the support leg without other actions, so as to improve the operation convenience of the child safety seat. The operation of folding and unfolding of the support leg is convenient and the reliability is good.

16. The driving member can not only realize the buffering function for the unfolding of the support leg, which prevents the support leg from being ejected too quickly and hitting the user or being damaged due to impact, but also lock and unlock the slider bracket and the base bracket.

17. The buffer may reduce noise and vibration caused by the unfolding of the support leg.

Other embodiments of the present application will readily occur to those skilled in the art after considering the specification and practicing the invention disclosed herein. The present application is intended to cover any variations, uses, or adaptations of the present application that follow the general principles of the present disclosure and include the common knowledge or conventional technical means in the art that are not disclosed in the present application. The specification and embodiments are to be considered exemplary only and the true scope and spirit of the present application are indicated by the claims of the present application.

Although the present application has been described with reference to typical embodiments, the terms used are illustrative and exemplary and are not limiting. Since the present application can be embodied in various forms without departing from the spirit and essence of the present application, it is therefore to be understood that the foregoing embodiments are not limited to any of the foregoing details, but are to be construed as broadly as defined by the claims, so that all variations falling within the scope of the claims or their equivalents are to be covered by the claims.

1-37. (canceled)

38. A base assembly, comprising:
a base;
a support leg;
a slider disposed slidably on the base, the support leg being pivotably connected to the slider and telescoped with the slider; and
a locking member for locking the slider to the base.

39. The base assembly according to claim 38, wherein the slider comprises a slider bracket, the base comprises a base bracket, and the slider bracket is sleeved on the base bracket and is slidable relative to the base bracket;
wherein the base assembly further comprises an unlocking member that releases the locking of the locking member to the slider and the base in response to pivot of the support leg relative to the slider in a first direction.

40. The base assembly according to claim 38, wherein the slider comprises a slider bracket, the base comprises a base bracket, and the slider bracket is sleeved on the base bracket and is slidable relative to the base bracket;
wherein a bushing is arranged between the slider bracket and the base bracket.

41. The base assembly according to claim 40, wherein the bushing is formed with an annular rib, the slider is formed with a slider groove, the annular rib is located on a side of the bushing, and the annular rib extends into the slider groove.

42. The base assembly according to claim 38, wherein the slider comprises a slider bracket, the base comprises a base bracket, and the slider bracket is sleeved on the base bracket and is slidable relative to the base bracket;
wherein the locking member comprises a locking pin, the slider bracket is formed with a locking hole, the base bracket is formed with another locking hole, and the locking pin passes through the locking hole and the another locking hole to lock the slider bracket with the base bracket; or wherein the locking member comprises a locking pin, a locking hole is formed on the slider bracket, a recess is formed on the base bracket, and the locking pin passes through the locking hole and enters the recess to lock the slider bracket with the base bracket.

43. The base assembly according to claim 42, wherein the locking member comprises an arm portion, a first end of the arm portion is formed with the locking pin, a second end of the arm portion is pivotably connected to the slider bracket.

44. The base assembly according to claim 43, wherein a convex portion is formed between the first end and the second end of the arm portion.

45. The base assembly according to claim 44, wherein the support leg pushes the second end when the support leg pivots from a folded position to an unfolded position.

46. The base assembly according to claim 44, wherein the locking member comprises a cam formed with a push protrusion radially projecting from the cam,
wherein when the support leg pivots relative to the slider in the first direction, the push protrusion actuates the convex portion, so that the locking member pivots relative to the second end in the first direction, thereby releasing locking between the slider bracket and the base bracket.

47. The base assembly according to claim 43, wherein a limiting portion is formed between the first end and the second end of the arm portion, and a movement distance of the limiting portion relative to the slider bracket is limited.

48. The base assembly according to claim 38, wherein the slider comprises a slider bracket, the base comprises a base bracket, and the slider bracket is sleeved on the base bracket and is slidable relative to the base bracket;
the locking member comprises a locking pin, a locking hole is formed on the slider bracket, a recess is formed on the base bracket, and the locking pin passes through the locking hole and enters the recess to lock the slider bracket with the base bracket; and
the locking member comprises a fixing cover, a fixing seat, and an elastic member, an interior of the fixing cover is formed as a chamber, the elastic member is disposed within the chamber, and the locking pin is at least partially disposed within the chamber.

49. The base assembly according to claim 48, wherein a lower end of the fixing cover is formed with an opening, and the elastic member applies a force to the locking pin tending to partially push the locking pin out of the opening.

50. The base assembly according to claim 38, further comprising a driving member,
wherein locking member is in responsive to pivot of the support leg, the driving member is connected to the support leg, and the slider is locked or unlocked with the base.

51. The base assembly according to claim 50, wherein the locking member is disposed on the slider, the base comprises a locking hole, and the locking member is inserted into the locking hole to lock the slider with the base, and
the driving member comprises:
a first end connected to the locking member; and
a second end abutting against the support leg when the support leg rotates to an angle.

52. The base assembly according to claim 50, wherein the driving member is a torsion spring and disposed on the slider.

53. The base assembly according to claim 39, wherein the slider comprises a pivot about which the support leg pivots, and the driving member is sleeved on the pivot.

54. The base assembly according to claim 38, wherein the base comprises a base upper cover and a base lower cover, a buffer is disposed on the base lower cover, and the slider abuts against the buffer when the slider moves toward the front of the base.

55. The base assembly according to claim 53, wherein the support leg has a rotation support, and an end of the rotation support is pivotably sleeved on the pivot, and
wherein the rotation support presses against the second end when support leg pivots, thereby pushing the second end to bias the first end against the locking member.

56. The base assembly according to claim 55, wherein the locking member tends to move in a direction of insertion into the locking hole when pressure applied by the first end to the locking member is greater than pressure applied by the reset member to the locking member; or
wherein the locking member tends to move in a direction away from the locking hole when pressure applied by the first end to the locking member is less than pressure applied by the reset member to the locking member.

57. A child safety seat comprising a base assembly and a seat arranged on the base assembly, wherein the base assembly is the base assembly according to claim 38.
